(19) United States
(12) Patent Application Publication
(10) Pub. No.: US 2016/0031207 A1
(43) Pub. Date: Feb. 4, 2016

(54) RECIPROCATING PRINT IMPARTED TO ANY PRODUCT WHERE THE INFORMATION CAN OR IS REQUIRED TO BE COMMUNICATED IN ANY NUMBER OF ORIENTATIONS

(71) Applicant: ROBERT PAUL ANDERSON, SACRAMENTO, CA (US)

(72) Inventor: ROBERT PAUL ANDERSON, SACRAMENTO, CA (US)

(21) Appl. No.: 14/450,086

(22) Filed: Aug. 1, 2014

(51) Int. Cl. B41F 33/00

(52) U.S. Cl. CPC B41F 33/00

(57) ABSTRACT

Reciprocating print (text, graphic, images, encodings, etc.) imparted to any product along multiple orientation configurations that correspond to multiple deployment configurations of the product is disclosed. Some embodiments include methods of displaying print information on a product and making products with displayed print information along multiple orientation configurations.

### BACKGROUND

Embodiments of the invention described in this specification relate generally to alignment and deployment of printed or displayed information, and more particularly, to methods of providing printed and displayed information on products such that the information is comprehensible regardless of deployment orientation of the product.

Certain products include displayed information or designs, such as text, graphics, and/or images, which is may be most readily comprehended by a viewer when the displayed information or designs are oriented in one or more particular manners. Examples of products with displayed information include barrier tape and caution tape. Barrier tape, caution tape, and other such products, regardless of the displayed text, graphics, or image, have the potential to be deployed in ways that do not coincide with the intended orientation of the displayed information. For example, caution tape may include multiple displays of the textual message “CAUTION” along the length of the tape, but a person may inadvertently use the tape in a way that the textual message is displayed upside down to an observer. In these instances, the information being relayed may not be fully comprehended by viewers.

Therefore, what is needed is a way to provide displayed information on a product in a comprehensible manner, such that the displayed information is oriented in a way in which a viewer can comprehend the information, regardless of the manner in which the product is deployed.

### BRIEF DESCRIPTION

Embodiments of the invention disclose print information displayed on a product, and methods of displaying print information on a product and making products with displayed print information, in each of a set display orientation configurations to impart one or more messages to a viewer of the product.

Some embodiments include a method for displaying print information on a product in a plurality of orientation configurations. In some embodiments, the method for applying the print information to the product in the plurality of orientation configurations includes steps for (i) identifying a viewer-comprehensible orientation configuration in which a display of the print information on the product is comprehensible to a viewer of the product, (ii) identifying each orientation configuration in the plurality of orientation configurations in which the print information can be applied to the product in satisfaction of the viewer-comprehensible orientation configuration, and (iii) displaying the print information on the product in each identified orientation configuration of the plurality of orientation configurations.

Some embodiments include a method for making a product with print information displayed in a plurality of orientation configurations on an exterior surface of the product. In some embodiments, the product is one of caution tape, barrier tape, burial tape, wire and conductor, and any other linearly manufactured items with displayed print information associated with an intended message or warning. By making such products with print information that is comprehensible in each of several different orientation configurations, a person need not worry about orienting the product in only one way during deployment. Thus, the methods described in this disclosure make it easy to read the information on the product regardless of deployment.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a perspective view of reciprocating print information displayed on a length of caution tape in some embodiments.

FIG. 2 conceptually illustrates a front view of reciprocating print displayed on a length of caution tape in some embodiments.

FIG. 3 conceptually illustrates a perspective view of reciprocating print displayed on a part of a wire in some embodiments.

FIG. 4 conceptually illustrates a perspective view of reciprocating print displayed on a length of burial tape in some embodiments.

FIG. 5 conceptually illustrates an a prior art bar code in a single orientation.

FIG. 6 conceptually illustrates a perspective view of reciprocating print displayed in two orientations for a bar code in some embodiments.

FIG. 7 conceptually illustrates a perspective view of reciprocating print displayed in four orientations for a bar code in some embodiments.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments include print information that is displayed on a product in each of a set display orientation configurations in order to impart one or more messages to a viewer of the product.

Some embodiments include a method for displaying print information on a product in a plurality of orientation configurations. In some embodiments, the method for applying the print information to the product in the plurality of orientation configurations includes steps for (i) identifying a viewer-comprehensible orientation configuration in which a display of the print information on the product is comprehensible to a viewer of the product, (ii) identifying each orientation configuration in the plurality of orientation configurations in which the print information can be applied to the product in satisfaction of the viewer-comprehensible orientation configuration, and (iii) displaying the print information on the product in each identified orientation configuration of the plurality of orientation configurations. In this way, communication and visibility are enhanced by displaying the print information on the product in the number of orientation configurations that correspond to the number of ways the product can be deployed, placed, or used. This allows the text, graphics, and/or images to be read regardless how the product was deployed.

Some embodiments include a method for making a product with print information displayed in a plurality of orientation configurations on an exterior surface of the product. In some embodiments, the product is one of caution tape, barrier tape, burial tape, wire and conductor, and any other linearly manufactured items with displayed print information associated with an intended message or warning. By making such products with print information that is comprehensible in each of several different orientation configurations, a person need not worry about orienting the product in only one way during deployment. Thus, the methods described in this disclosure make it easy to read the information on the product regardless of deployment.

As stated above, products such as barrier tape or caution tape (regardless of text, graphics, encodings, or image printed) have the potential to be deployed in manners where the text, graphics, encodings, and/or images are displayed upside down from the perspective of viewers (e.g., human viewers, machine viewers, etc.) who see the products after deployment but who cannot read or comprehend the message conveyed by the text, graphics, encodings, and/or images because the text, graphics, encodings, and/or images are oriented differently from their intended deployment orientation. Embodiments of the invention described in this specification solve such problems employing multiple orientations in the display of print information, such as text, graphics, encodings, and/or images, on a product in order to enhance communication and visibility of the print information. By displaying the print information in multiple orientations, the text, graphics, encodings, or images may be readable or comprehensible to a person or machine (e.g., a bar code scanner, a QR code scanner, etc.) regardless of how the product is deployed, thereby eliminating situational deployment issues where text, graphics, and/or images are not readable or comprehensible as intended. Thus, the problem of ‘improper’ deployment is eliminated because the print is displayed in at least one proper orientation regardless of the deployment.

By way of example, FIG. 1 conceptually illustrates a perspective view of reciprocating print information displayed on a length of caution tape 10. As shown in this figure, a length of caution tape 10 includes a printed surface 12 with textual representations of information (i.e., “CAUTION”) displayed in two orientation configurations: a first orientation configuration 14 in which the textual information is displayed or appears upright and readable; and a second inverted orientation configuration 16 in which the textual information is displayed or appears upside down and may be less readable to a person.

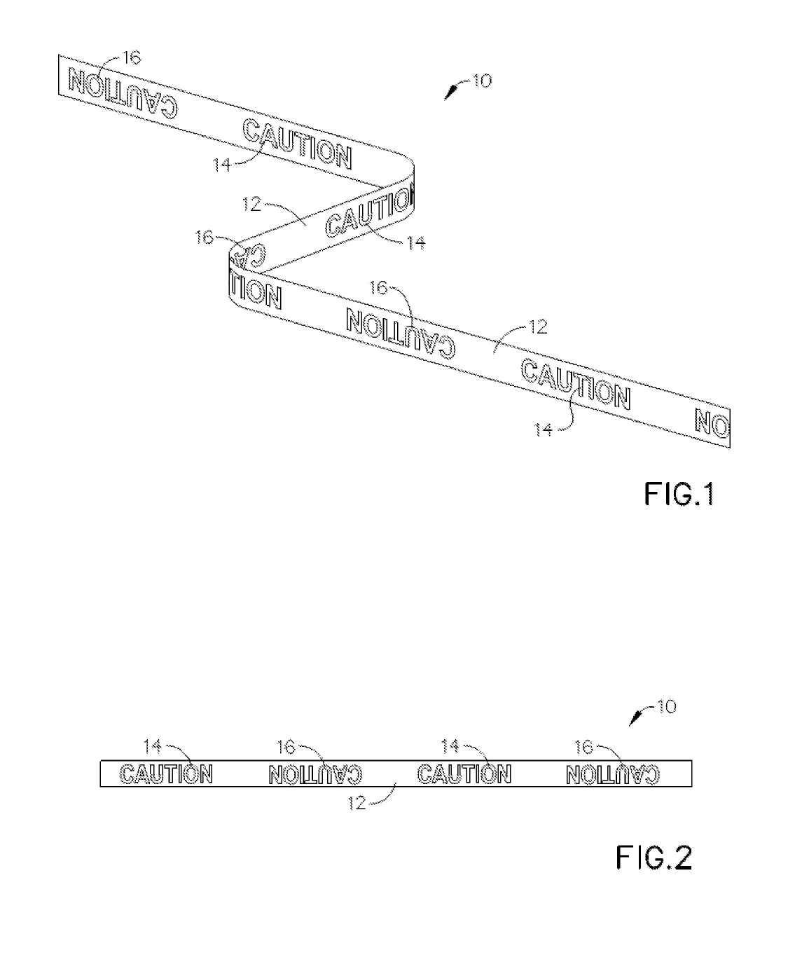

This is also shown in FIG. 2, which conceptually illustrates a front view of the reciprocating print information displayed on the length of caution tape 10. As shown, the print information (i.e., “CAUTION”) is readable to a person regardless of the manner in which the caution tape 10 is deployed. The length of tape 10 may be deployed, for example, in a manner that displays the textual information of the second inverted orientation configuration 16 upside down with respect to the person and, therefore, displays the textual information of the first orientation configuration 14 right-side up for the person to read. On the other hand, if the caution tape 10 is deployed another way, the textual information of the second inverted orientation configuration 16 may be displayed in an upright, readable manner to a person viewing the caution tape 10, while the textual information of the first orientation configuration 14 may appear upside down. Whatever the deployment, however, the person will be able to read the textual information in at least one of the two reciprocating print orientation configurations.

The embodiments described in this specification differ from and improve upon currently existing ways of conveying information on products. In particular, displaying print information on a product in each of a set of different orientation configurations differs from print information displayed in a single orientation on existing products because the print information on such existing products can easily be deployed in a manner in which text, graphics, and images are upside down or angled in way that makes it difficult for a person to comprehend the information after the existing product is deployed, placed, or used. For example, in some existing products, the displayed text, graphics, or images are oriented in a way that makes it easier to read from the side or upside down, simply because the deployment, placement, or use of the product resulted in the displayed print information to be viewable in some incomprehensible or difficult way to read. If the intended message is upside down or angled in a way that makes the print less readily readable, then partial or full miscommunication may occur, resulting in work or safety errors and/or liability based on a product that was not deployed, placed, or used in a way that displays the message as intended. In contrast, the multiple print information display orientations of the present disclosure ensure that a message, a warning, or other information is conveyed to a person viewing the product in a way that is readily perceived and comprehensible to the person, regardless of how the product is deployed. Accordingly, the multiple orientation configurations used to display the print information include a sufficient number of orientation configurations in the display of the print information so that deployment, placement, or use of the product in any way will properly convey the message.

The print information display orientation configurations of the present disclosure may be comprised of the following elements. This list of possible constituent elements is intended to be exemplary only and it is not intended that this list be used to limit the print information display orientation configurations of the present application to just these elements. Persons having ordinary skill in the art relevant to the present disclosure may understand there to be equivalent elements that may be substituted within the present disclosure without changing the essential function or operation of the print information display orientation configurations.

1. A tangible product that imparts a message

2. Message information to convey to a person viewing the product

3. Print symbols and/or representations of the message information displayed in a comprehensible orientation on the product to convey the message information to the person while the person is viewing the product (e.g., text, graphics, or images printed on barrier tape, caution tape, or other products that may need the information to be displayed on the product in a particular orientation in order for a person to readily perceive and/or comprehend the information).

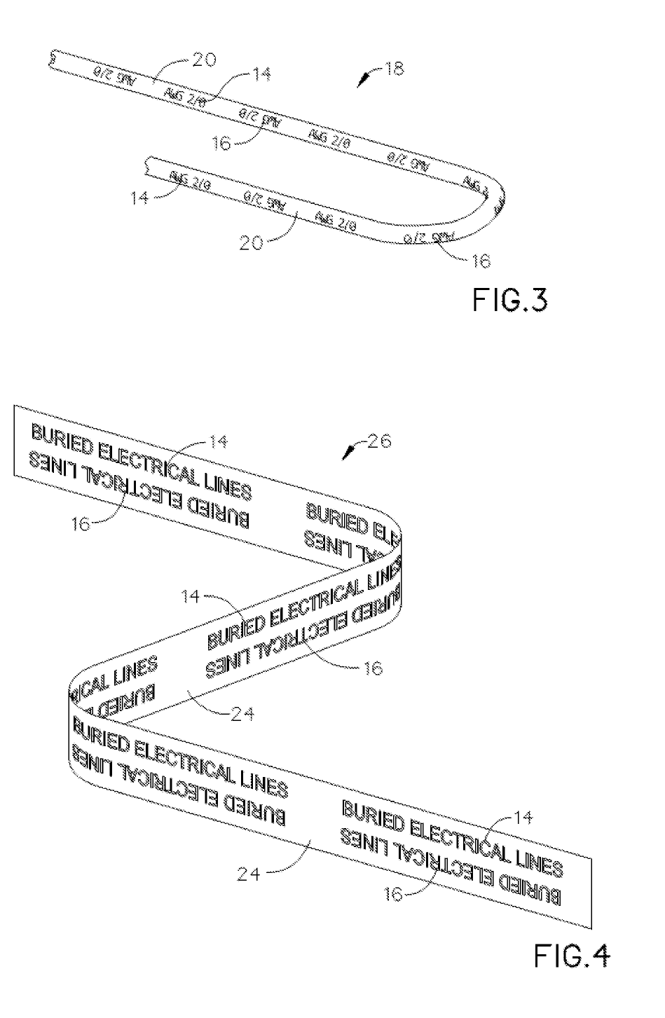

By way of example, FIG. 3 conceptually illustrates a perspective view of reciprocating print 18 displayed on a part of a wire. As shown in this figure, the reciprocating print 18 includes print information displayed on an exterior surface 20 of the wire according to a first orientation configuration 14 and a second inverted orientation configuration 16.

The multiple oriented print information and methods of the present disclosure generally work by determining how many manners of deploying, placing, or using a product are possible, and then displaying the print information in a number of orientations to cover the possible number of manners of deployment, placement, or usage of the product. For example, a single orientation of a displayed message on barrier tape, caution tape, and similar items cannot always ensure that horizontal deployment of the tape conveys the message as intended because the displayed message may be upside down. In contrast, the methods of some embodiments allow text, graphics, and images to be displayed in reciprocating or multiple display orientations so that the message for the print information is readily communicated to viewers.

By way of example, FIG. 4 conceptually illustrates a perspective view of reciprocating print 26 displayed on a length of burial tape 24. As shown in this figure, the reciprocating print 26 includes print information displayed on both sides of the burial tape 24 according to a first orientation configuration 14 and a second inverted orientation configuration 16.

While many of the examples described by reference to FIGS. 1-4 pertain to reciprocating alpha-numeric character print displayed on types of tape or wire, in some embodiments, the subject matter of the print is not human-readable, but may be machine readable. Examples of machine readable print include bar codes, QR codes, packaging symbols, and other machine readable coded information that is typically printed on exterior surfaces of boxes or products. FIG. 5 conceptually illustrates an example of a prior art bar code 28 in a single orientation. In order for the information associated with the bar code to be captured by a bar code scanner, the bar code needs to be oriented in a manner that allows a laser of the scanner to span the horizontal length of the bar code in the correct upright orientation.

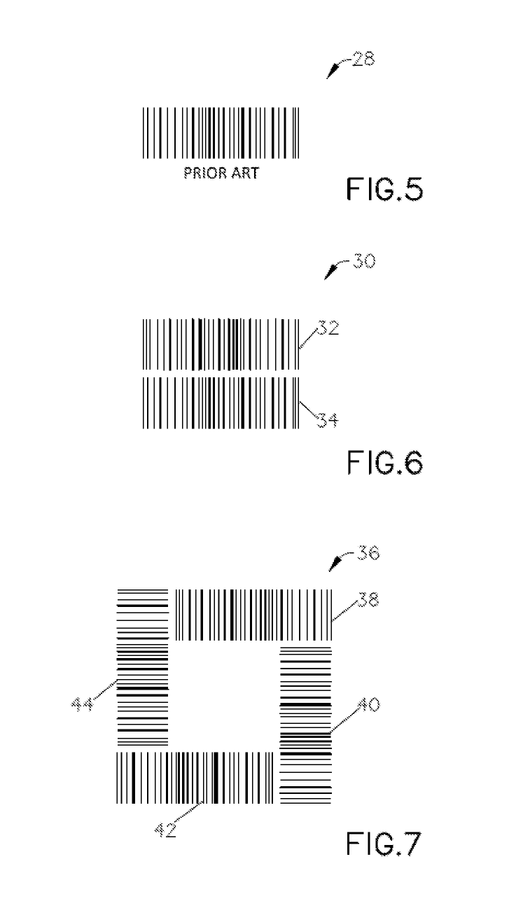

In contrast, some embodiments provide multiple orientations of machine-readable encoding print. By way of example, FIG. 6 conceptually illustrates a perspective view of reciprocating print 30 displayed in two orientations for a bar code in some embodiments. As shown in this figure, the top bar code 32 is displayed in an upright orientation, while the bottom bar code 34 is displayed in an orientation that is the reverse of the top bar code 32 orientation and is upside down in relation to the top bar code 32 orientation. Thus, a bar code scanner would be able to read either the top bar code 32 or bottom bar code 34 to capture the information associated with the bar codes.

In another example, multiple orientations can be laid out in a variety of orientations, such as having four bar codes in different orientations. FIG. 7 conceptually illustrates a perspective view of reciprocating print 36 displayed in four orientations for a bar code in some embodiments. As shown in this figure, a single bar code is printed in four different orientations. Specifically, along the top is the bar code 38 in an upright orientation. Along the right side is the bar code 40 in a downward sideways orientation with respect to the top bar code 38. Along the bottom is the bar code 42 in an upside down, reverse orientation with respect to the top bar code 38. Also, along the left side is the bar code 44 in an upward sideways orientation. By having four orientations of a printed bar code, a bar code scanner would be able to scan any one of the bar codes and capture the information of all the bar codes (i.e., the four bar codes have the same information, so scanning any one of them will capture the information of any one of them).

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

I claim:

1. A method for displaying print information on a product in a plurality of orientation configurations, the method comprising:
identifying a viewer-comprehensible orientation configuration in which a display of the print information on the product is comprehensible to a viewer of the product;
identifying each orientation configuration in the plurality of orientation configurations in which the print information can be applied to the product in satisfaction of the viewer-comprehensible orientation configuration; and
displaying the print information on the product in each identified orientation configuration of the plurality of orientation configurations.

2. The method of claim 1, wherein the viewer-comprehensible orientation configuration is a horizontal orientation.

3. The method of claim 2, wherein the plurality of orientation configurations comprises an upright horizontal orientation and an upside down horizontal orientation.

4. A method for making a product that imparts a message by a set of print information that is displayed on a surface of the product, the method comprising:
identifying a set of product deployment configurations in which the product is at least one of deployed, placed, and used;
orienting the print information in correspondence with each identified product deployment configuration; and
applying the set of oriented print information to the product.

5. The method of claim 4, wherein the set of product deployment configurations comprises a horizontal deployment configuration.

6. The method of claim 5, wherein said applying the set of oriented print information to the product comprises:
applying the print information in an upright horizontal orientation; and
applying the print information in an upside down horizontal orientation.

7. The method of claim 6, wherein each upright horizontal orientation of the print information corresponds vertically to an upside down horizontal orientation of the print information.

8. The method of claim 7, wherein at least one upright horizontal orientation of the print information is displayed above the vertically corresponding upside down horizontal orientation of the print information.

9. The method of claim 7, wherein at least one upside down horizontal orientation of the print information is displayed above the vertically corresponding upright horizontal orientation of the print information.

10. The method of claim 6, wherein the application of each upright horizontal orientation of the print information alternates with the application of an upside down horizontal orientation of the print information.

11. The method of claim 4, wherein the set of product deployment configurations comprises a set of four angled deployment configurations.

12. The method of claim 11, wherein a first angled deployment configuration is offset from a horizontal deployment configuration by a particular number of degrees.

13. The method of claim 12, wherein a second angled deployment configuration is offset from the first angled deployment configuration by ninety degrees, a third angled deployment configuration is offset from the second angled deployment configuration by ninety degrees, and a fourth angled deployment configuration is offset from the third angled deployment configuration by ninety agrees.

14. The method of claim 4, wherein the product is one of caution tape, burial tape, and wire.
